(19) United States
(12) Patent Application Publication
(10) Pub. No.: US 2012/0230661 A1
(43) Pub. Date: Sep. 13, 2012

(54) Apparatus and Method for Control of a Thermostat

(75) Inventor: Esan A. Alhilo, Florissant, MO (US)

(73) Assignee: EMERSON ELECTRIC CO., St. Louis, MO (US)

(21) Appl. No.: 13/468,304

(22) Filed: May 10, 2012

Related U.S. Application Data
(63) Continuation-in-part of application No. 12/268,898, filed on Nov. 11, 2008, now Pat. No. 8,190,296.

(51) Int. Cl. F24H 1/18; B23K 13/08

(52) U.S. Cl. 392/441; 219/482

(57) ABSTRACT

Controllers and methods for activating a switching device to apply electrical power to a heating element are provided. One example controller includes a temperature sensor disposed within the fluid and configured to sense an ambient temperature of the fluid, a switching device configured to apply electrical power to a heating element, and a processor coupled to the temperature sensor and the switching device. The processor is configured to determine a temperature delta value based on the sensed ambient temperature from the temperature sensor and a set point temperature, to determine an offset based on an average duty cycle of a switching device for a predetermined number of historical time intervals, and to calculate a duty cycle based on the temperature delta value and the offset.

### CROSS-REFERENCE TO RELATED APPLICATION

This application is a continuation-in-part of U.S. patent application Ser. No. 12/268,898 filed Nov. 11, 2008, which will issue May 29, 2012 as U.S. Pat. No. 8,190,296. The entire disclosure of the above application is incorporated herein by reference.

### FIELD

The present disclosure relates to apparatus and methods for control of a thermostat or other devices.

### BACKGROUND

This section provides background information related to the present disclosure which is not necessarily prior art.

Heating systems that use line voltages of 120 volts or 240 volts are typically switched on or off by a thermostat. Such thermostats may employ electromechanical relays or solid state switches to switch line voltage to the heating element or load. While electromechanical relays offer the advantage of switching with minimum power dissipation when the relay is on, solid state switching devices have the disadvantage that they typically include a voltage drop that results in heat dissipation, where the heat dissipated can adversely affect the thermostat's temperature sensing element. This increased temperature in the sensing element affects the sensor's ability to accurately sense the rise in ambient temperature, and causes the thermostat switch to open and turn off the heating unit before the ambient temperature increases sufficiently to the desired temperature. Such inaccuracy in control could cause the ambient temperature swings within the control space to become excessive because of the sensor differential caused by heat dissipated by the switch.

### SUMMARY

This section provides a general summary of the disclosure, and is not a comprehensive disclosure of its full scope or all of its features.

In one aspect of the present disclosure, a controller for activating a switching device to apply electrical power to a heating element is provided. The controller includes a processor configured to receive, from a temperature sensor, a temperature signal indicative of an ambient temperature of a fluid within a space, to determine a temperature delta value indicative of a difference between the ambient temperature and a set point temperature, and to determine an offset based on an average duty cycle of a switching device for a predetermined number of historical time intervals. The processor is further configured to calculate a duty cycle for controlling the switching device based on the temperature delta value and the offset and to activate the switching device according to the calculated duty cycle, to thereby control the extent of electrical power applied to the heating element.

In another aspect of the present disclosure, a controller for activating a switching device to apply electrical power to a heating element is provided. The controller includes a temperature sensor disposed within the fluid and configured to sense an ambient temperature of the fluid, a switching device configured to apply electrical power to a heating element, and a processor coupled to the temperature sensor and the switching device. The processor is configured to determine a temperature delta value based on the sensed ambient temperature from the temperature sensor and a set point temperature, to determine an offset based on an average duty cycle of a switching device for a predetermined number of historical time intervals, and to calculate a duty cycle based on the temperature delta value and the offset. The processor is further configured to activate the switching device according to the calculated duty cycle, to thereby control the extent of electrical power applied to the heating element.

In yet another aspect of the present disclosure, a method for activating a switching device to apply electrical power to a heating element is provided. The method includes receiving a temperature signal indicative of an ambient temperature of a fluid within a space, determining a temperature delta value indicative of a difference between the ambient temperature and a set point temperature, determining an offset based on an average duty cycle of a switching device for a predetermined number of historical time intervals, calculating a duty cycle for controlling the switching device based on the temperature delta value and the offset, and activating the switching device according to the calculated duty cycle, to thereby control the extent of electrical power applied to the heating element.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a thermostat having a temperature sensing device within a compartment according to an exemplary embodiment;

FIG. 2 is a flow chart representing an exemplary embodiment of a method for controlling a thermostat having a temperature sensor; and

FIG. 3 is a flow chart of another exemplary embodiment of a method for controlling a thermostat having a temperature sensor.

### DETAILED DESCRIPTION

Example embodiments will now be described more fully with reference to the accompanying drawings.

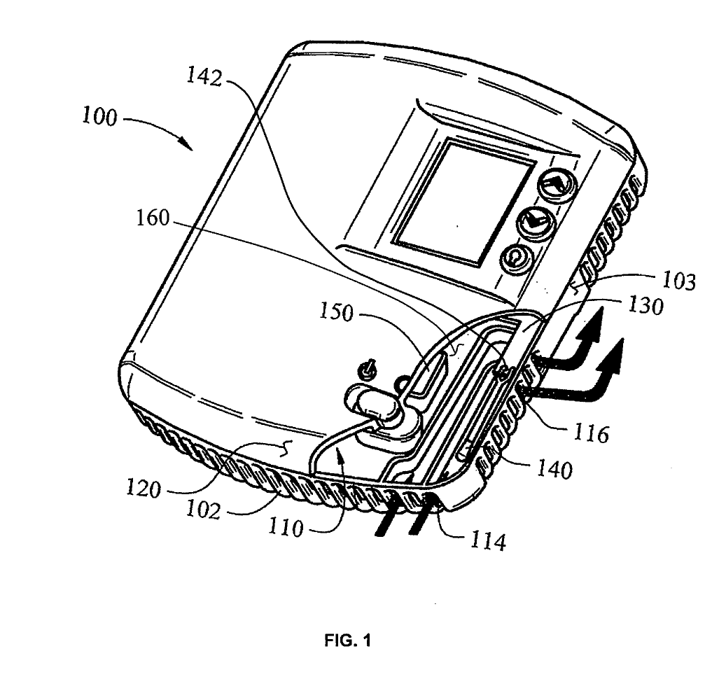

Referring to FIG. 1, a first exemplary embodiment of a thermostat 100 is shown that includes a temperature sensor inside the thermostat 100. This illustrated thermostat 100 is one example of a controller, which is usable to control application of electrical power to a heating element to provide one or more heating operations to a space, such as a house, a building, a water tank of a water heater, etc.

As shown in FIG. 1, the thermostat 100 includes a base portion 102 and a cover portion 120 that mate to form a housing that includes a circuit board. In the exemplary embodiment, the thermostat 100 includes an interior space 110, in which a temperature sensor 140 is positioned along a side wall 103 of the thermostat 100. In other embodiments, a temperature sensor may be disposed outside of the thermostat 100 or other controller, but within the space to be heated.

The thermostat 100 further includes a first aperture 114 in the thermostat 100 near the lower portion of the thermostat 100. This first aperture 114 permits communication of airflow in a lower portion of the interior space 110 of the thermostat 100. The thermostat 100 includes a second aperture 116 disposed in the thermostat 100 above the first lower aperture 114, where the second upper aperture 116 permits communication of airflow from within the interior space 110 of the thermostat 100.

The temperature sensor 140 is provided within the interior space 110 of the thermostat 100, which includes electrical leads 142 extending to a circuit board 130. The thermostat 100 may include electrical components that generate heat, such as a switching device configured to switching device a line voltage source to a load. For example, the switching device may be a Field Effect Transistor (FET), Triac device, or other solid-state type of switching device that is positioned inside or outside the housing. The thermostat 100 may further include a heat sink 160 associated with the switching device 150, where the heat sink 160 is disposed within a portion of the interior space of the thermostat 100. The air heated by the switching device 150 or heat sink 160 rises upward and escapes through aperture 116 or vents in the top of the thermostat 100. This heated air escaping the thermostat housing creates a chimney effect that draws ambient air in through aperture 114 in the bottom of the thermostat 100. The heated air rising through the thermostat 100 creates an upward draft of airflow, which has the effect of pulling heat out of the interior of the thermostat 100. The heat generated by the switching device and dissipated by the heat sink 160 can negatively affect the ability of the temperature sensor 140 to accurately sense the ambient temperature in the space. A second temperature sensor adjacent the heat sink 160 could be used for sensing the temperature of the heat sink 160, which could be used for offsetting the ambient temperature sensed by temperature sensor 140. But this approach would entail added complexity and cost associated with the second sensor.

The thermostat 100 includes an improved means of controlling the application of electrical power to a heating element for controlling the ambient temperature within a space. The thermostat 100 comprises a single temperature sensor 140 that is configured to communicate a value indicative of the ambient temperature in the space to be heated. The thermostat 100 includes a switching device 150 disposed within or outside the thermostat 100 and configured to apply electrical power to a heating element when the switching device 150 is activated. The heat sink 160 is associated with the switching device 150 and configured to dissipate heat generated by the switching device 150.

The thermostat 100 further includes a processor configured to periodically determine a temperature delta value indicative of the difference between the sensed ambient temperature and a desired set point temperature. The processor is also configured to calculate a percentage of a finite switching time period (e.g., between 15 and 30 seconds, etc.) for activating the switching device 150. The processor is operable for activating the switching device for the determined percentage for the finite switching time period, to thereby control the extent of electrical power applied to the heating element. More specifically, the processor is configured to calculate the percentage based on the temperature delta value and at least a heat dissipation offset that is determined based on an average of a predetermined number of prior switching percentages.

The thermostat 100 is configured to control the switching device 150 to control how long electrical power is switched to the heating load in a given switching time period, to thereby supply only the power required by the heating load to maintain the desired temperature. The determination of the percentage of the switching time period for activating the switching device is sometimes called a duty cycle. The percentage or duty cycle is determined based on the difference between the latest buffered temperature reading and the desired set point. This essentially is the difference between the Set-Point Temperature (SPT) and the Ambient Temperature (AT) (which may be represented by and referred to herein as the equation SPT-AT). The percentage or duty cycle is also determined based on a heat sink offset, which may also be called a temperature compensation drift offset.

In the first exemplary embodiment, the controller is configured to determine the extent of time that power is to be switched to a heating load for a given switching time period, to maintain the ambient temperature within 2 degrees Celsius of the set point temperature. In the first embodiment, the switching time period is approximately 20 seconds. The controller is configured to measure the ambient temperature once every 6 seconds. The sensed ambient temperature, which may be at some fractional amount between integer values (e.g., 23.66 degrees Celsius, etc.) is then matched to or assigned a thermostat buffered temperature. The difference between the set point temperature and the ambient temperature sensed by element 140 is called the SPT-AT temperature delta, where the SPT-AT temperature delta value is the difference between the temperature set point and the thermostat buffered temperature. This temperature delta value is assigned a value in increments of 5 of between 0 and 200. Specifically, the controller assigns an incremental temperature value for up to 20 counts of one degree Celsius (1 degree Celsius=100 counts). Thus, the difference or SPT-AT temperature delta value is expressed as a value between 0 and 200 corresponding to a temperature difference between 0 and 2 degrees Celsius.

The controller then calculates the duty cycle that determines the percentage of the time period that power is to be applied to the heating load, such as an electric baseboard heater or a heating element of (e.g., thermistor within, etc.) an electric water heater, depending on the SPT-AT temperature delta value. The minimum SPT-AT delta is zero. The maximum SPT-AT delta is 200 counts (2 degrees Celsius). If the ambient temperature does differ from the set point temperature by more than 2 degrees Celsius (such as when the thermostat, other HVAC control, etc. is first activated), the SPT-AT delta value will be assigned a maximum value of 200 counts (2 degrees Celsius). The controller will update the duty cycle calculation once every 20 seconds. Finally, the controller converts the calculated duty cycle to a firing rate signal, which is used to regulate the electronic controller. The firing rate signal duration is the ON time in seconds that the controller operates or activates the switching device.

An example of this determination of a duty cycle determination is shown below. The determination of a firing rate (or percentage of the switching time period) is illustrated by the data in TABLE 1 shown below. For example, if the calculated SPT-AT temperature delta value is 1 degree (or 100 counts) then the duty cycle is 50% and the firing rate duration is 10 seconds, where the controller turns the heating system ON for 10 seconds and OFF for 10 seconds.

TABLE 1

| SPT-AT | Duty | Firing |
|---|---|---|
| delta | cycle | rate |
| 0 | 0% | 0 |
| 10 | 5% | 1 |
| 20 | 10% | 2 |
| 30 | 15% | 3 |
| 40 | 20% | 4 |
| 50 | 25% | 5 |
| 60 | 30% | 6 |
| 70 | 35% | 7 |
| 80 | 40% | 8 |
| 90 | 45% | 9 |
| 100 | 50% | 10 |
| 110 | 55% | 11 |
| 120 | 60% | 12 |
| 130 | 65% | 13 |
| 140 | 70% | 14 |
| 150 | 75% | 15 |
| 160 | 80% | 16 |
| 170 | 85% | 17 |
| 180 | 90% | 18 |
| 190 | 95% | 19 |
| 200 | 100% | 20 |

To maintain an optimized (or improved) heating system performance that achieves a precise desired temperature set point, the controller is configured to compensate for the temperature drift due to heat dissipation by the heat sink that raises the temperature inside the thermostat, which dissipation is based on the percentage or duty cycle at which the switching device is being operated. Specifically, the heat sink of the thermostat may dissipate heat depending on heat system current and the duty cycle. The greater the percentage the longer the time that the switching device is activated and applying electrical power, which, in turn, generates more heat. The heat sink dissipation raises the temperature inside the thermostat (or other control) proximate to the temperature sensor and also causes a drift in the sensed ambient temperature. Thus, the thermostat determines a heat dissipation offset as a function of the percentage of time or duty cycle at which the switching device has historically been activated, such that the offset is based on the heating system's past performance.

Specifically, the heat dissipation offset is determined based on an average of a predetermined number of duty cycle values for prior finite time intervals. The controller keeps a log of the heating percentage or duty cycle data for each finite time period, storing the duty cycle data once every 20 second interval for a time period of up to about an hour. The duty cycle data for prior finite time intervals over the past hour are summed and averaged to determine an average duty cycle value. The average duty cycle value is utilized to generate the controller's heat sink offset value or heat dissipation offset. This offset will be added to the SPT-AT delta to calculate the duty cycle percentage and firing rate for each subsequent finite interval over the next hour. The heat dissipation value depends on the amount of heat that the heat sink dissipates, which depends on the current that is being drawn by the heating load. Because the temperature sensor 140 is affected by the amount of heat dissipated by the heat sink in the thermostat, controlling the heating system to accurately maintain temperature is critically dependent on the amount of current being drawn.

The thermostat may be configured to permit a user to select the current level setting, or the thermostat may employ a sensor to detect the level of current draw. Where a low current heating load (e.g., 500-2000 watts, etc.) is selected and may draw a current of only 4 amps, the algorithm uses a first equation or look-up table to determine a “light” heat sink offset value. If a high current heating load (e.g., 2000-4000 watts, etc.) is selected, which may draw a current of 12 amps or more, the algorithm uses a second equation or look-up table to determine a “heavy” heat sink offset value. The thermostat calculates either a light current heat sink offset or a heavy current heat sink offset. The light current heat sink offset=(firing rate×10)+15, and the heavy current heat sink offset=(((firing rate×10)+15)×2)+70+firing rate. Table 2 shows heat dissipation offset values for a light current load (e.g., 4 Amps, etc.) and heavy current load (e.g., 12 Amps, etc.).

TABLE 2

| | | | |
|---|---|---|---|
| 0% | 0 | 15 | 100 |
| 5% | 1 | 25 | 121 |
| 10% | 2 | 35 | 142 |
| 15% | 3 | 45 | 163 |
| 20% | 4 | 55 | 184 |
| 25% | 5 | 65 | 205 |
| 30% | 6 | 75 | 226 |
| 35% | 7 | 85 | 247 |
| 40% | 8 | 95 | 268 |
| 45% | 9 | 105 | 289 |
| 50% | 10 | 115 | 310 |
| 55% | 11 | 125 | 331 |
| 60% | 12 | 135 | 352 |
| 65% | 13 | 145 | 373 |
| 70% | 14 | 155 | 394 |
| 75% | 15 | 165 | 415 |
| 80% | 16 | 175 | 436 |
| 85% | 17 | 185 | 457 |
| 90% | 18 | 195 | 478 |
| 95% | 19 | 205 | 499 |
| 100% | 20 | 215 | 520 |

The controller may preferably be a proportional-integral-derivative (PID) controller that will preferably maintain a duty cycle based on the SPT-AT delta, which, in turn, will lead to keeping the room temperature below the desired set point. For example, if the duty cycle is 50%, the PID controller will preferably maintain a temperature of 1 degree Celsius below the desired set point. This offset is designed to help the heating system achieve the user's desired temperature with respect to the running heating duty cycle. The controller accordingly uses an algorithm to determine the percentage or duty cycle of on-time of power to a heating load during a finite interval, based on a calculation that is a function of the difference between the Set-Point Temperature (SPT) and sensed Ambient Temperature (AT), plus a duty cycle offset that is an averaged duty cycle value multiplied by a duty cycle multiplier (e.g., −2, etc.), plus a second heat sink factor (e.g., 8, etc.), the sum of which is multiplied by a current multiplier (e.g., 4, etc.).

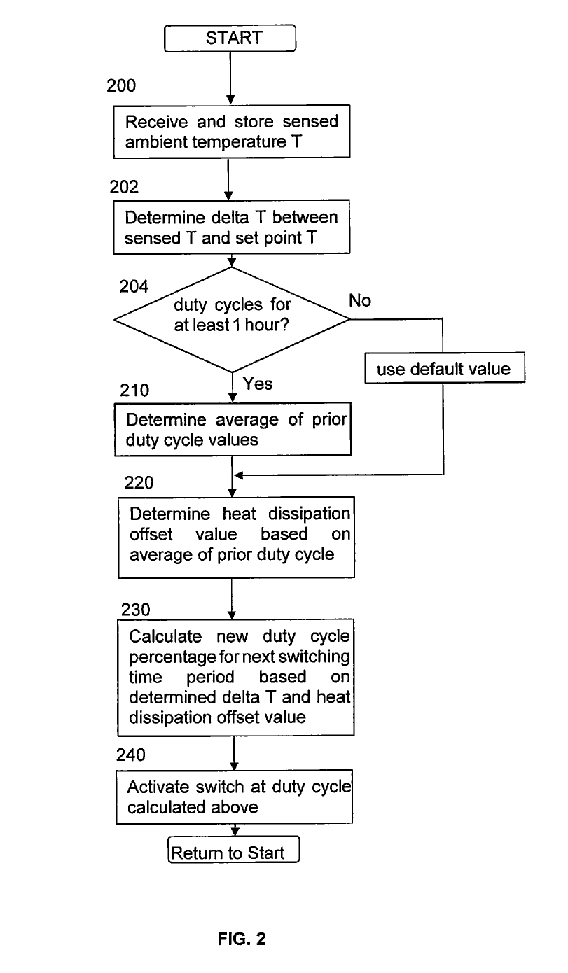

Referring now to FIG. 2, there is shown a flow chart representing an exemplary embodiment of a method for controlling the application of power by a thermostat to a heating load. In this exemplary embodiment, the method first determines a temperature delta value indicative of the difference between the sensed temperature and a desired set point temperature at step 202. At step 210, the method then determines the average of a number of prior duty cycle values (or switching percentages), where such prior duty cycle values exist. If there are not a sufficient number of prior duty cycle values, a default value is used in place of the determined average. The method then determines at step 220 a heat dissipation offset value that is based on the average of prior determined duty cycle switching percentages. From the preceding values determined in the above steps, the method proceeds at step 230 to calculate a duty cycle percentage for a finite switching time period in which the switching device is to be activated, based on the temperature delta offset value, and a heat dissipation offset value (which is a function of or based on the average of prior calculated switching percentages).

Once the method has calculated a duty cycle switching percentage of the finite time period in which to activate the switching device, the method then calls for activating the switching device for the determined percentage of the switching time period at step 240. The activation of the switching device for only a percentage of a total switching time period limits the extent of electrical power that is applied to a heating element or load, to thereby control the amount of heat that is being generated by the heating element or load. Using the above method for determining and adjusting the percentage of time in which a switching device is activated to apply power to a heating element, a thermostat is capable of more effectively controlling the heat source to more accurately control the temperature within the space being heated so as not to overshoot the set point, and thereby provide more energy-efficient heating.

In a second embodiment, the thermostat may be configured to determine how long electrical power is switched to a heating load in a finite switching time period of about 20 seconds, to regulate within a shorter interval the power required to maintain the desired temperature. The controller is configured to measure the ambient temperature once every 6 seconds. The sensed ambient temperature, which may be at some fractional amount between integer values, is matched to or assigned a buffered temperature value, as an incremental temperature value for up to 20 counts of one degree Celsius (1 degree Celsius=100 counts). The difference between the set point temperature and the ambient temperature sensed by element 140 is called the SPT-AT temperature delta, where the SPT-AT temperature delta value is the difference between the temperature set point and the thermostat buffered temperature. This temperature delta value is assigned a value in increments of 5 between 0 and 200.

The controller assigns an incremental temperature value for up to 20 counts of one degree Celsius (1 degree Celsius=100 counts). Thus, the SPT-AT temperature delta value is expressed as a value between 0 and 200 corresponding to a temperature difference between 0 and 2 degrees Celsius. The controller then calculates a duty cycle that represents the percentage of the finite time period that power is to be applied to the heating load, such as an electric baseboard heater, based in part on the SPT-AT temperature delta value. The minimum SPT-AT delta is zero. The maximum SPT-AT delta is 200 counts (2 degrees Celsius). If the ambient temperature does differ from the set point temperature by more than 2 degrees Celsius (such as when the thermostat is first activated), the SPT-AT delta value will be assigned a maximum value of 200 counts (2 degrees Celsius). The controller will determine a duty cycle calculation once every finite time period, or every 20 seconds. The controller converts the calculated duty cycle to a firing rate signal, which is used to regulate the electronic controller. The firing rate signal duration is the ON time in seconds that the controller operates or activates the switching device, to power the heating load during a portion of the finite time period. The controller employs an algorithm to determine the firing rate for each finite time interval.

In the second embodiment, the first step of the algorithm is to calculate a new SPT-AT delta value at the end of a 20 second time interval. The algorithm's next step is to calculate a duty cycle value for the next 20 second time interval. The next time interval duty cycle value is equal to the set point temperature expressed as a value between 0 and 200 corresponding to a temperature delta between 0 and 2 degrees Celsius, plus a duty cycle offset value and a heat sink offset value. The duty cycle offset value and heat sink offset value are values that are recalculated every hour, and are used in calculating the duty cycle for each 20 second interval in the following hour.

The determination of a firing rate (or percentage of the switching time period) is illustrated by the data in TABLE 3 shown below. The algorithm also determines firing rate, which is reflective of calculated duty cycle value for the next time interval. For example, if the calculated SPT-AT temperature delta value is 1 degree (or 100 counts) then the duty cycle is 50% and the firing rate duration is 10 seconds. This means that the electronic controller will turn the heating system ON for 10 seconds and OFF for 10 seconds repeatedly.

TABLE 3

| SPT-AT | Duty | Firing |
|---|---|---|
| delta | cycle | rate |
| 0 | 0% | 0 |
| 10 | 5% | 1 |
| 20 | 10% | 2 |
| 30 | 15% | 3 |
| 40 | 20% | 4 |
| 50 | 25% | 5 |
| 60 | 30% | 6 |
| 70 | 35% | 7 |
| 80 | 40% | 8 |
| 90 | 45% | 9 |
| 100 | 50% | 10 |
| 110 | 55% | 11 |
| 120 | 60% | 12 |
| 130 | 65% | 13 |
| 140 | 70% | 14 |
| 150 | 75% | 15 |
| 160 | 80% | 16 |
| 170 | 85% | 17 |
| 180 | 90% | 18 |
| 190 | 95% | 19 |
| 200 | 100% | 20 |

The method used by the algorithm also stores historical duty cycle values by storing or summing each duty cycle value determined for each 20 second interval. Initial duty cycle default value is 50%. Based on the initial duty cycle value of 50%, the algorithm determines a duty cycle offset value. Every hour, the number of stored duty cycle calculations over the last hour are averaged, to determine a new average duty cycle over the past hour. This new average duty cycle is multiplied by a duty cycle factor or multiplier (e.g., 10, etc.) to calculate a new duty cycle offset value as shown in Table 4 below.

TABLE 4

| Duty | Firing | Duty Cycle |
|---|---|---|
| cycle | rate | Offset |
| 0% | 0 | 0 |
| 5% | 1 | 10 |
| 10% | 2 | 20 |
| 15% | 3 | 30 |
| 20% | 4 | 40 |
| 25% | 5 | 50 |
| 30% | 6 | 60 |
| 35% | 7 | 70 |
| 40% | 8 | 80 |
| 45% | 9 | 90 |
| 50% | 10 | 100 |
| 55% | 11 | 110 |
| 60% | 12 | 120 |
| 65% | 13 | 130 |
| 70% | 14 | 140 |
| 75% | 15 | 150 |
| 80% | 16 | 160 |
| 85% | 17 | 170 |
| 90% | 18 | 180 |
| 95% | 19 | 190 |
| 100% | 20 | 200 |

To maintain an optimized (or improved) heating system performance that achieves a precise desired temperature set point, the controller is configured to compensate for the temperature drift due to heat dissipation by the heat sink raising the temperature inside the thermostat, which dissipation is based on the percentage or duty cycle at which the switching device is being operated. Specifically, the heat sink of the thermostat may dissipate heat depending on heat system current and the duty cycle. The greater the percentage the longer the time that the switching device is activated and applying electrical power, which, in turn, generates more heat. The heat sink dissipation raises the temperature inside the thermostat and also causes a drift in the temperature measurement. Accordingly, the controller determines a heat dissipation offset as a function of the percentage of time or duty cycle at which the switching device is activated, where the offset is based on the heating system's past performance. More specifically, the heat dissipation offset is determined based on an average of a predetermined number of prior switching percentages. The controller keeps a log of the heating percentage or duty cycle data, storing the percentage data once every 20 seconds for the past hour. Those heating duty cycle data are averaged and utilized to generate the controller's heat dissipation offset. This offset will be added to the SPT-AT delta to calculate the duty cycle and the firing rate. The algorithm selects either a light current heat sink offset or a heavy current heat sink offset.

The thermostat may be configured to permit a user to select the current level setting, or the thermostat may employ a sensor to detect the level of current draw. In selecting a low current heating load (e.g., 500-2000 watts, etc.) that may draw a current of only 4 amps, the light current heat sink offset is calculated as the new duty cycle offset plus a first heat sink factor (e.g. 15, etc.). Where a high current heating load (e.g., 2000-4000 watts, etc.) is selected, the heavy current heat sink offset is determined based on whether the duty cycle was less than 50% or greater than 50%. Where the duty cycle is less than 50%, the heavy current heat sink offset is equal to the new duty cycle offset plus a second heat sink factor (e.g. 8, etc.), the sum of which is multiplied by a heavy current multiplier (e.g., 4, etc.). Where the duty cycle is greater than 50%, the heavy current heat sink offset is equal to the new duty cycle offset plus a third heat sink factor (e.g., 7, etc.), the sum of which is multiplied by a heavy current multiplier (e.g., 4, etc.). The heat sink offset value and duty cycle offset value are then stored, and both the stored heat sink offset and duty cycle offset values are used in subsequent duty cycle calculations for finite time intervals over the next hour. An example of heat dissipation offset values are shown in Table 5 below, which includes heat sink offsets for light current (etc., 4 Amps, etc.) and heavy current (e.g., 16 Amps, etc.).

TABLE 5

| Duty | Firing | Light HS | Heavy HS |
|---|---|---|---|
| cycle | rate | Offset | Offset |
| 0% | 0 | 15 | 32 |
| 5% | 1 | 25 | 72 |
| 10% | 2 | 35 | 112 |
| 15% | 3 | 45 | 152 |
| 20% | 4 | 55 | 192 |
| 25% | 5 | 65 | 232 |
| 30% | 6 | 75 | 272 |
| 35% | 7 | 85 | 312 |
| 40% | 8 | 95 | 352 |
| 45% | 9 | 105 | 392 |
| 50% | 10 | 115 | 428 |
| 55% | 11 | 125 | 468 |
| 60% | 12 | 135 | 508 |
| 65% | 13 | 145 | 548 |
| 70% | 14 | 155 | 588 |
| 75% | 15 | 165 | 628 |
| 80% | 16 | 175 | 668 |
| 85% | 17 | 185 | 708 |
| 90% | 18 | 195 | 748 |
| 95% | 19 | 205 | 788 |
| 100% | 20 | 215 | 828 |

The PID controller will preferably maintain a duty cycle based on the SPT-AT delta, which will lead to keeping the room temperature below the desired set point. For example, if the duty cycle is 50%, the PID controller will preferably maintain a temperature of 1 degree Celsius below the desired set point. This offset is designed to help the heating system achieve the user's desired temperature with respect to the running heating duty cycle. The controller accordingly uses an algorithm to determine the percentage or duty cycle of on-time of power to a heating load during a finite interval, based on a calculation that is a function of the difference between the Set-Point Temperature (SPT) and sensed Ambient Temperature (AT), plus a duty cycle offset that is an averaged duty cycle value multiplied by a duty cycle multiplier (e.g., −2, etc.), plus a second heat sink factor (e.g., 4 to 8, etc.), the sum of which is multiplied by a current multiplier (e.g., 1 to 4, etc.).

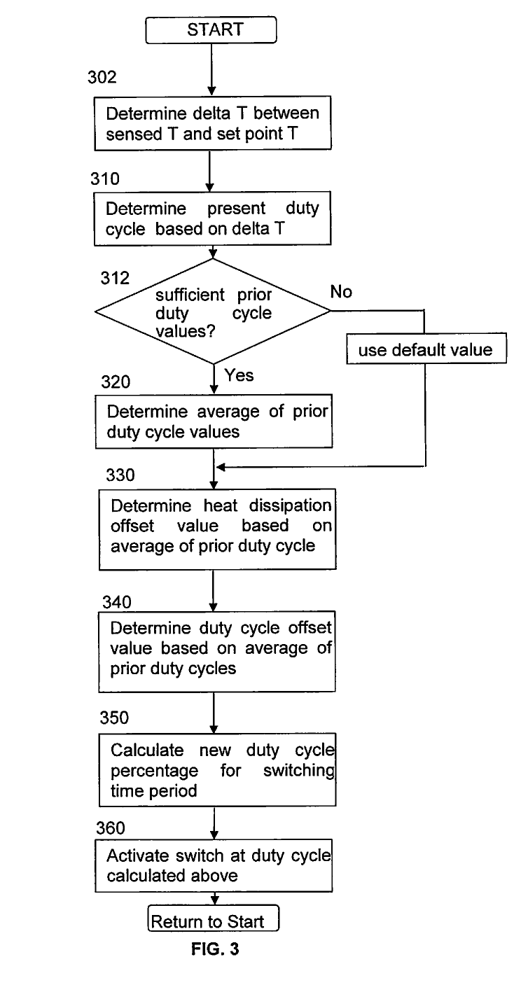

Referring to FIG. 3, there is shown a flow chart representing a second exemplary embodiment of a method for controlling the application of power by a thermostat to a heating load. In this second embodiment, the thermostat comprises a temperature sensor configured to communicate a value indicative of the ambient temperature in the space to be heated, and a switching device configured to apply electrical power to a heating element when the switching device is activated. The thermostat further comprises a heat sink associated with the switching device. The heat sink is configured to dissipate heat generated by the switching device. A processor is operable for controlling the switching device. The processor is configured to determine (e.g., periodically, etc.), for a finite switching time period, a temperature delta value indicative of the difference between the sensed temperature and a desired set point temperature. The processor is configured to determine a percentage of the switching time period that the switching device is activated, based on the temperature delta value and a heat dissipation offset that is a function of an average of a predetermined number of prior switching percentages. The processor is further configured to activate the switching device for the determined percentage of the switching time period, to thereby control the extent of electrical power applied to the heating element. The heat dissipation offset value varies proportionally with respect to the averaged switching percentages.

In accordance with the flow chart shown in FIG. 3, the processor is further configured to calculate a ratio of a switch activation time to the total switching time period as a function of the temperature delta value, a duty cycle offset that is based on an average of a predetermined number of prior switching ratios, and a heat dissipation offset that is based on the average of a predetermined number of prior switching ratios. As shown in FIG. 3, the second embodiment of a method first determines a temperature delta value indicative of the difference between the sensed temperature and a desired set point temperature at step 302. At step 310, the method then determines a duty cycle based on the temperature delta value, which duty cycle is used in determining a percentage of a finite switching period in which a switching device is activated. At step 320, the method then determines the average of a number of prior switching ratios (or firing rates as calculated using the look-up table percentages, where prior calculated switching ratios exist). If there are not a sufficient number of prior calculated percentages, a default value is used in place of the determined average. The method then determines at steps 330 and 340 both a duty cycle offset value and a heat dissipation offset value, which are based on the average of a number of prior switching ratios. From the preceding values determined in the above steps, the method proceeds at step 350 to calculate a firing rate or percentage of a finite switching time period in which a switching device is to be activated based on the temperature delta value, the duty cycle offset value, and a heat dissipation offset value (which is a function of or based on the average of prior calculated switching percentages). Once the method has calculated a percentage of the finite time period in which to activate the switching device, the method then calls for activating the switching device for the determined percentage of the switching time period at step 360. The activation of the switching device for only a percentage of a total switching time period limits the extent of electrical power that is applied to a heating element or load, to thereby control the amount of heat that is being generated by the heating element or load. By using this exemplary method for determining and adjusting the percentage of time in which a switching device is activated to apply power to a heating element, a thermostat is capable of more effectively controlling the heat source to more accurately control the temperature within the space being heated. From the above, the processor is configured to activate the switching device for the calculated ratio of the total switching period, to thereby control the extent of electrical power applied to the heating element.

Accordingly, exemplary embodiments are disclosed herein of thermostats, other controls (e.g., control for an electric water heater, an HVAC control, etc.) and methods for controlling operation of the same by calculating a given duty cycle factor using an average of a pre-determined number historical cycles. In exemplary embodiments, using a single temperature sensor within a thermostat provides for operating the thermostat to maintain a tight differential temperature of 2 degrees, which avoids temperature overshoot and promotes energy savings. This advantage may be achieved by using a controller and algorithm as disclosed herein for controller operation of a thermostat (e.g., thermostat that controls line voltage heating loads, etc.), other HVAC controls, other controls (e.g., control for an electric water heater, etc.).

It will be understood by those skilled in the art that the temperature compensation algorithms disclosed in the above embodiments may be employed in a wide range of other controls in addition to thermostats that are used or designed to control a cooling load or a heating load. Accordingly, the disclosed embodiments, and variations thereof may be employed in any apparatus utilizing a switching device for controlling one or more heating loads. By way of example, exemplary embodiments may include using a temperature sensor (e.g., thermistor remote from a control, etc.) for operating an electric water heater control to maintain a tight differential temperature of the hot water and to help avoid temperature overshoot and promotes energy savings. This may be achieved by using a controller and algorithm as disclosed herein to provide a continuously variable control for the electric water heater, which also would not necessarily include the heat sink offset as part of the algorithms.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements may be present. For example, one or more resistors may be coupled between two elements, which are “connected” to one another. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A controller for activating a switching device to apply electrical power to a heating element, the controller comprising:
a processor configured to receive, from a temperature sensor, a temperature signal indicative of an ambient temperature of a fluid within a space, to determine a temperature delta value indicative of a difference between the ambient temperature and a set point temperature, and to determine an offset based on an average duty cycle of a switching device for a predetermined number of historical time intervals;
wherein the processor is configured to calculate a duty cycle for controlling the switching device based on the temperature delta value and the offset and to activate the switching device according to the calculated duty cycle, to thereby control the extent of electrical power applied to the heating element.

2. The controller of claim 1, wherein the processor is configured to apply, via the switching device, a line voltage source to the heating element according to the calculated duty cycle.

3. The controller of claim 1, wherein the offset includes a heat dissipation offset to compensate for a response of the temperature sensor to the heat generated by the switching device.

4. The controller of claim 3, wherein the processor is configured to calculate said duty cycle based on the heat dissipation offset and the temperature delta value, only when the temperature delta value is below a threshold, the threshold representative of at least about 2 degrees Celsius.

5. The controller of claim 3, wherein the processor is configured to calculate the duty cycle to reduce the temperature delta to less than about 2 degrees Celsius.

6. The controller of claim 1, further comprising a housing, a switching device disposed within the housing, and a temperature sensor disposed within the housing and positioned proximate to the switching device;
wherein the switching device is coupled to the processor and configured to apply electrical power to the heating element based on the calculated duty cycle.

7. The controller of claim 1, wherein the processor is further configured to store a duty cycle for each of the predetermined number of historical time intervals, the predetermined number of historical time intervals including time intervals within a last hour.

8. The controller of claim 1, wherein the offset includes a duty cycle offset, the processor configured to determine the duty cycle offset based on the average duty cycle of the switching device and a duty cycle multiplier.

9. The controller of claim 1, wherein the processor is configured to determine the offset based on a current drawn through the switching device during at least one of the historical time intervals.

10. A controller for activating a switching device to apply electrical power to a heating element for heating a fluid within a space, the controller comprising:
a temperature sensor disposed within the fluid and configured to sense an ambient temperature of the fluid;
a switching device configured to apply electrical power to a heating element; and
a processor coupled to the temperature sensor and the switching device, the processor configured to determine a temperature delta value based on the sensed ambient temperature from the temperature sensor and a set point temperature, to determine an offset based on an average duty cycle of a switching device for a predetermined number of historical time intervals, and to calculate a duty cycle based on the temperature delta value and the offset;
wherein the processor is configured to activate the switching device according to the calculated duty cycle, to thereby control the extent of electrical power applied to the heating element.

11. The controller of claim 10, further comprising a housing in which are disposed the temperature sensor and the switching device.

12. The controller of claim 10, wherein the temperature sensor is disposed proximate to the heating element for heating the fluid within the space.

13. The controller of claim 10, wherein:
the offset includes a heat dissipation offset indicative of a response of the temperature sensor to the heat generated by the switching device; and
the processor is configured to determine a present duty cycle based on the temperature delta value and to calculate said duty cycle based on the present duty cycle and the heat dissipation offset.

14. The controller of claim 10, wherein the controller includes a thermostat for controlling a heating system.

15. A method for activating a switching device to apply electrical power to a heating element, the method comprising:
receiving, from a temperature sensor, a temperature signal indicative of an ambient temperature of a fluid within a space;
determining, at a processor, a temperature delta value indicative of a difference between the ambient temperature and a set point temperature;
determining, at the processor, an offset based on an average duty cycle of a switching device for a predetermined number of historical time intervals;
calculating a duty cycle for controlling the switching device based on the temperature delta value and the offset; and
activating the switching device according to the calculated duty cycle, to thereby control the extent of electrical power applied to the heating element.

16. The method of claim 15, wherein the offset includes a heat dissipation offset indicative of a response of the temperature sensor to the heat generated by the switching device.

17. The method of claim 15, wherein determining the temperature delta includes periodically determining the temperature delta.

18. The method of claim 17, wherein determining the offset based on the average duty cycle of the switching device includes determining the offset based on the average duty cycle of the switching device at least once per hour.

19. The method of claim 17, wherein determining the offset includes retrieving a default offset when there is less than the predetermined number of historical time intervals.

20. The method of claim 15, further comprising storing the calculated duty cycle in memory.
